(19) United States
(12) Patent Application Publication
(10) Pub. No.: US 2005/0005264 A1
(43) Pub. Date: Jan. 6, 2005

(54) Computer programming object externalization

(76) Inventors: Michael N. Gurevich, Walnut Creek, CA (US); Aram Airapetian, Walnut Creek, CA (US)

Correspondence Address: MORRISON & FOERSTER LLP, 425 MARKET STREET, SAN FRANCISCO, CA, 94105-2482, US

(21) Appl. No.: 10/903,650

(22) Filed: Jul. 29, 2004

Related U.S. Application Data
(63) Continuation of application No. 09/360,103, filed on Jul. 23, 1999.

(51) Int. Cl. G06F 9/44

(52) U.S. Cl. 717/116; 717/120; 717/108

(57) ABSTRACT

Methods and apparatus are disclosed to facilitate and conduct the programming and implementation of object-oriented computer programs with improved object externalization and internalization. Program code allows an instance of a user-defined class to be viewed by other program elements as a block of memory containing one or more data items. The data items are the attributes of the object instance. An attribute map effectively describes the object instance by indicating, for example, the location of a particular attribute within the memory block. The attribute map may also directly or indirectly indicate, for example, the size of the attribute, the type of the attribute, and whether the attribute is rudimentary or aggregate in composition. Other program code, external to the object, uses a pointer to the object and the attribute map to externalize the object, i.e., transform the representation of an object to a secondary format. The secondary format may be used to convey the object outside the bounds of the program that contains it. Program code practicing the present invention makes a user-defined object more resilient to technology change. Because specific information about the external format used to represent the object is not integral to the object, a change in external format does not require a change to the object, and a class declaration (header) file for an object, together with its implementation file in executable form, can be made externalizable and internalizable to virtually an unlimited number of external formats.

### CROSS-REFERENCE TO RELATED APPLICATIONS

The present application is a continuation of U.S. patent application Ser. No. 09/360,103, titled COMPUTER PROGRAMMING OBJECT EXTERNALIZATION, filed on Jul. 23, 1999.

### BACKGROUND OF THE INVENTION

1. Field of the Invention

This invention relates to the field of data-processing, in particular to the externalization of computer program objects.

2. Description of Related Art

It is typical for the programming and development of a large-scale computer application to span a period of two to three years, and for maintenance to span five years or more beyond that. Technologies used in the programming and development of such systems, in contrast, are emerging with a yearly pace. For example, CORBA, DCOM, and enterprise JAVA beans (EJB) component technologies became viable alternatives in a period of three years from 1996 to 1998. This discrepancy between life cycles of applications and the technologies used to develop and deploy them is increasing.

The component technologies just mentioned all relate to data-processing using object-oriented computer programs. The widespread industry commitment to object-oriented technology stems from the promise of the technology to improve reuse and maintainability of data-processing applications built using object-oriented programs. This promise is undermined, however, where the software objects are constructed with a dependency on some underlying or related technology. Such an object cannot be immediately reused in a computing system employing a different technology. Similarly, such an object must be maintained when a different technology is put to use in its computing system.

The component technologies mentioned above intend to enhance object oriented's promise of reuse by scaling the unit of reusable programming code to something larger than a single programming object, i.e., a component. These technologies have not, however, provided an industry solution for building either objects or components that are resilient to technology changes. While providing for greater reuse via their component architectures, they contribute to diminished reuse by exacerbating the technology change problem.

Software objects constructed for use with such component technologies often contain within themselves an externalization/internalization facility that is directly dependent on the particular component technology. (The externalization/internalization facility is used to move a programming object between components.) FIG. 1 depicts an example object externalization employed in the prior art. The component technology provides a base class definition 100 from which all other classes are derived. The base class definition 100 includes an operation for externalization 102, e.g., externalize( ). Each particular class definition, e.g., ClassA and ClassZ, also includes an externalize( ) operation by inheritance from the base class 100. Accordingly, each object instantiated during program execution will have program code to perform an externalize( ) operation directly associated with it. Examples include ClassA object 110 and ClassZ object 120. Other program code in the application will execute 114, 124 the externalize( ) operation 112, 122 in order to have the object externalize itself, presumably for transport to another component. If the underlying technology were to change bringing about a new base class, all of the programming objects would have to be reconstructed to make corresponding changes in their externalization operations. Such a change would not uncommonly involve hundreds or even thousands of computer program modules and the objects they contain.

Consequently, there is a need in the art for externalization and internalization of programming objects that are resilient to technological change.

### SUMMARY OF THE INVENTION

Methods and apparatus are disclosed to facilitate and conduct the programming and implementation of object-oriented computer programs with improved object externalization and internalization. Program code allows an instance of a user-defined class to be viewed by other program elements as a block of memory containing one or more data items. The data items are the attributes of the object instance. An attribute map effectively describes the object instance by indicating, for example, the location of a particular attribute within the memory block. The attribute map may also directly or indirectly indicate, for example, the size of the attribute, the type of the attribute, and whether the attribute is rudimentary or aggregate in composition.

Other program code, external to the object, uses a pointer to the object and the attribute map to externalize the object. Externalization involves transforming the representation of an object to a secondary format. The secondary format may be used to convey the object outside the bounds of the program that contains it. Internalization is the logically reverse process.

Program code to facilitate the development and/or implementation of data-processing systems employing the improved externalization/internalization may advantageously be provided in a generalized form to application developers. Providing such program code aids standardization and reduces the burden on the computer programmer.

Program code practicing the present invention makes a user-defined object more resilient to technology change. Because specific information about the external format used to represent the object is not integral to the object, a change in external format does not require a change to the object. Moreover, the same object can be externalized to, or internalized from, multiple formats. Accordingly, a class declaration (header) file together with its implementation file in executable form can be made externalizable and internalizable to virtually an unlimited number of external formats.

These and other purposes and advantages of the present invention will become more apparent to those skilled in the art from the following detailed description in conjunction with the appended drawings.

### BRIEF DESCRIPTION OF THE DRAWINGS

FIG. 1 depicts object externalization employed in the prior art.

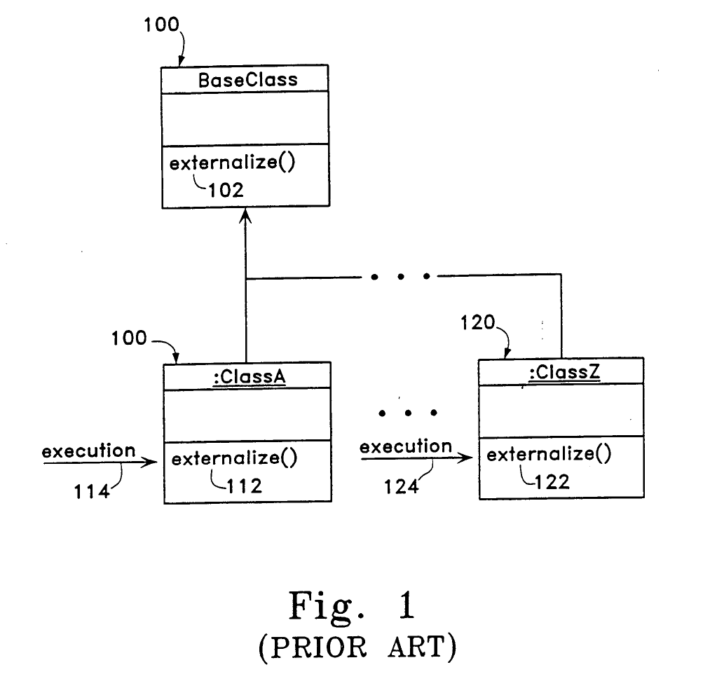

FIG. 2 depicts a representative computer system useful in the practice of the invention.

FIG. 3 is a block diagram for software development and execution.

FIG. 4 depicts a various life-cycle embodiments of computer programming objects.

FIG. 5 is a class diagram for computer programming objects useful in an embodiment employing the invention.

FIG. 6 is a block diagram illustrating exemplary programming objects and their related attribute maps.

FIG. 7 depicts the source code for the execute( ) operation of an Externalizer class.

FIG. 8 depicts an expanded class diagram for a sample embodiment employing the invention.

### DETAILED DESCRIPTION

The present invention provides for externalization and internalization of programming objects that are resilient to technological change. In the following description, numerous details are set forth in order to enable a thorough understanding of the present invention. However, it will be understood by those of ordinary skill in the art that these specific details are not required in order to practice the invention. Further, well-known elements, devices, process steps and the like are not set forth in detail in order to avoid obscuring the present invention.

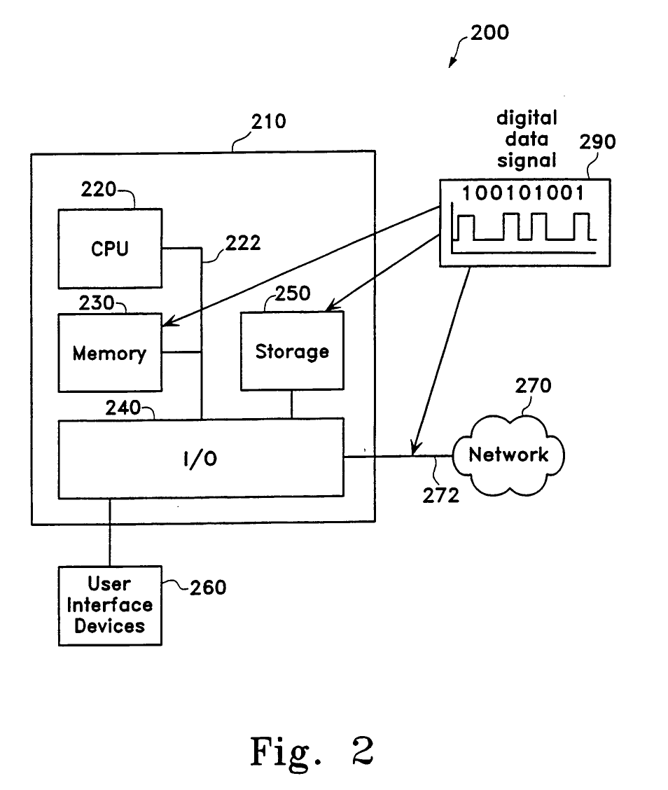

The invention relates to data-processing systems that employ computer programs using object oriented technology. FIG. 2 depicts a representative computer system useful in the practice of the invention. The computer system 200 includes a computer 210 with attached user interface devices 260 and connection 272 to a network 270. The computer 210 has a CPU 220, memory 230, I/O 240, and storage 250.

The CPU 220 executes instructions. The memory 230 holds instructions for the CPU 220 to execute and data to be processed thereby. (Note that, generally, except in regards to their execution, program instructions are handled, treated, and often considered as data.) The memory 230 may include one or more types of memory devices including, but not limited to, RAM, ROM, and flash memory. I/O 240 includes circuitry and devices for providing and receiving data to and from the CPU bus 222—either to and from circuitry and devices included in I/O 240, or to and from circuitry and devices interfaced thereby.

Storage 250 includes circuitry, devices, and media used to hold data. Storage 250 may include one or more device and media types including, but not limited to, fixed disks, removable disks, magnetic tape, CD-ROM, DVD, solid-state memory cards, and magneto-optical disks. Storage 250 is often characterized as holding a large volume of persistent copies of data.

User interface devices 260 includes those devices used to interact with a human user of the computer system. User interface devices 260 may include, without limitation, display screens, keyboards, pointing devices, microphones, and speakers. The network connection 272 permits the computer to interchange data with other computing devices which are themselves attached to the network 270.

The utility of the computer system 200 is in processing data represented in the form of digital signals, e.g., 290. The digital data signal may be persistent, where, for example, the carrier of the digital data signal is a recording media. The various media used in storage 250 are such examples. The digital data signal may also be transient, such as in the case of the network connection 272 where the carrier is an electrical current conducted along a wire or cable, or transmitted through the air.

A computer system such as described above in relation to FIG. 2 is useful throughout the life-cycle of an object-oriented computer program. A programmer uses such a computer system under the control of development software to create an object-oriented computer program that is ready for execution. (The development software itself may have been first created using such a computer system.) The computer operator uses such a computer system under the control of the object-oriented computer program software to achieve the data-processing result for which it was intended.

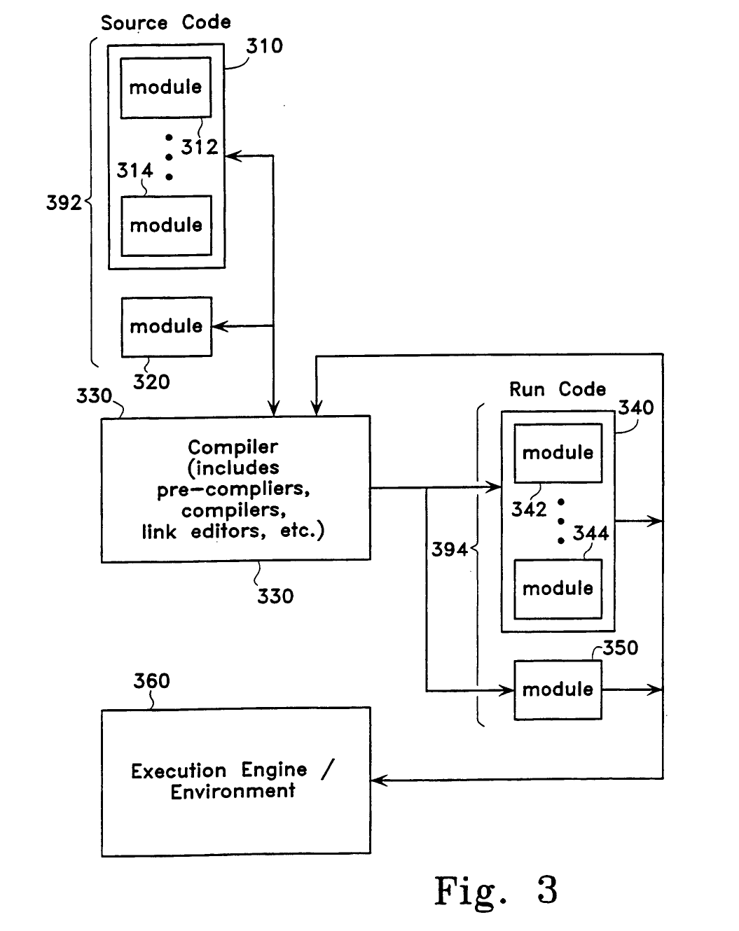

FIG. 3 is a block diagram showing certain elements involved in software development and execution. Development of an object-oriented computer program generally starts with source code 392. The term “source code” is generally used to describe a program in its original form as written by the programmer. The source code 392 is stored in a format readily susceptible to human interpretation and manipulation. A source code module 312, 314, 320 may contain a complete computer program or, more commonly, some coherent subsection of a larger program. A source code module may exist as an independent file 320 on the computer system or it may exist as a member 312, 314 of a library 310 containing many modules. Further, one skilled in the art recognizes that a source code module, or any other program element discussed herein, subsists in the digital data signal that represents it. As discussed above, the same digital data signal is susceptible to representation on any of an ever-increasing number of possible carriers, each having various characteristics.

One or more source code 392 modules become input to an executing compiler program 330. “Compiler” is generally used to refer to a program that reads a source code program and converts it to a condensed format more efficient for execution by the computer, e.g., object code. However, as used herein, the meaning of “compiler” 330 includes any of various programs used to convert its input to an output that is in a greater state of readiness for execution. Examples include pre-processors, pre-compilers, language compilers, and linkage editors. The meaning of the verb “compile” in any form as used herein is likewise extended accordingly. The one or more source code modules are read by the compiler and one or more output modules are created. An output module may be another source code 392 module as is the case where the compiler program is a language pre-processor. An output module may also be a run code 394 module as is the case where the compiler program is a linkage editor.

A run code module 342, 344, 350 is generally stored in a format that is efficient for machine processing but, accordingly, is not readily susceptible to human interpretation. A run code module may be either immediately executable or it may require further compiling, such as by a linkage editor, before it may be executed by the computer. A run code module in either an intermediate or directly-executable form may contain a complete computer program or some coherent subsection of a larger program. A run code module may exist as an independent file 350 on the computer system or it may exist as a member 342, 344 of a library 340 containing many modules.

A run code 394 module that is in directly-executable form becomes the input to an execution engine or execution environment 360. The most common execution engine/environment 360 is the operating system software controlling a computer. Other possible execution engine/environments include, for example, A JAVA virtual machine. The execution engine 360 interprets the instructions represented by the run code and performs corresponding data-processing operations. The execution engine 360 may also provide the means for linking the run code at execution time with other run code modules it needs to achieve its intended data-processing goal.

The preceding discussion makes it apparent that a computer program, or an individual module thereof, may be represented by a computer in various formats depending, at least in part, on its stage of executability. The program code of a computer program comprises not only the executing copy in memory, but the source code, object code, and any other predecessor or intermediate forms leading to the execution copy. The objects of object-oriented computer programs, accordingly, may exist in various formats subject to the program modules that contain them. Describing certain of these various formats will aid an understanding of the present invention.

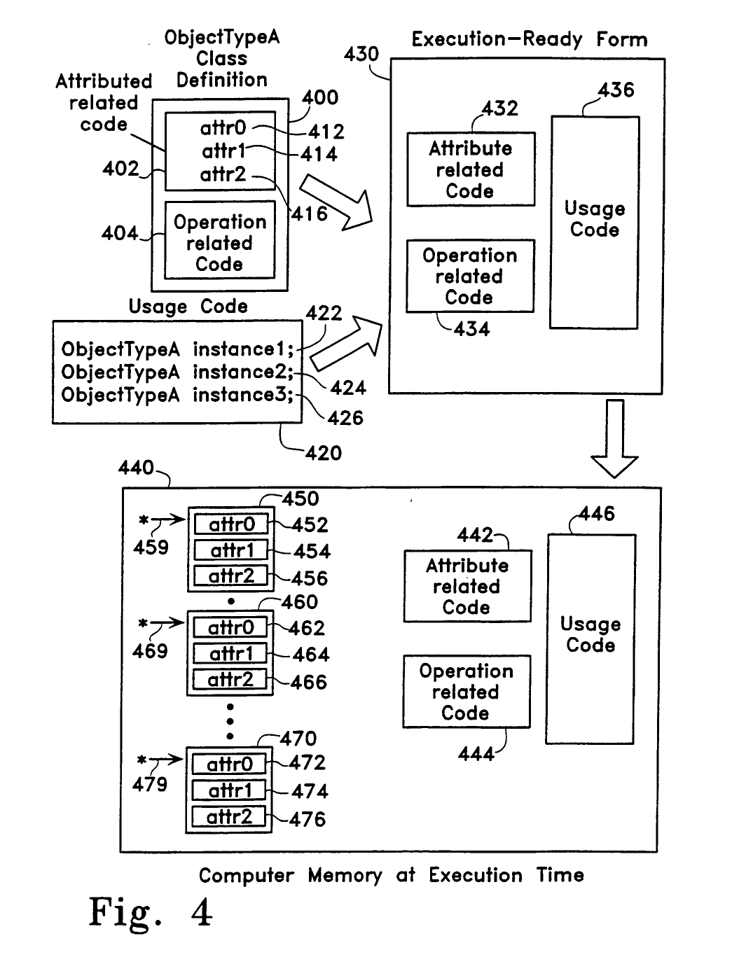

FIG. 4 depicts various life-cycle embodiments of computer programming objects. Every object belongs to a class and is said to be an “instance” of that class. The object, accordingly, generally starts with program code for a class definition. Simply put, a class can be said to be a kind or type of object. A class definition specifies the attributes and operations that an object of the class has.

A representation of a class definition 400 for a sample class named ObjectTypeA appears in FIG. 4. The class definition 400 includes attribute-related source code 402 and operation-related source code 404. The attribute-related source code 402 specifies the names of data values that will be associated with an object of the class. For example, if objects of class ObjectTypeA were each used to represent an automobile, attributes may include make and model. Three neutral attribute names are shown instead for the ObjectTypeA class definition including attr0 412, attr1 414 and attr2 416. The operation-related source code 404 specifies the names of operations an object of the class can perform, and includes the data-processing instructions to perform each operation. For example, if objects of class ObjectTypeA were each used to represent an automobile, operations may include, e.g., renew_registration( ) and transfer_title( ). Specific operation names for sample class definition ObjectTypeA are not shown.

In actual practice programmers often use two program code modules to provide a class definition. These modules are not, however, divided according to the attribute-operation distinction. Rather, a first module, called a header file, makes declarations about objects of the class. Declarations may include, for example, the names of operations and attributes that other program elements can directly use. The header file generally contains all the information needed to compile a program module that uses an object of the respective class. A second module, called an implementation file, provides detailed code including, for example, the specific instructions used to perform the object's operations.

Note also that terminology varies among proponents of object-oriented programming, while the same basic division between data values and data-processing actions persists. Attributes are also commonly called properties. Operations are also commonly called methods or behaviors.

Other source code is used by a programmer to specify the creation of an object. The usage code 420 depicted in FIG. 4 calls for the creation of three different objects each defined by the ObjectTypeA class. The three objects are named instance1, instance2, and instance3. The source code for the ObjectTypeA class definition 400 and the usage code 420 may be contained in the same or different source code modules. The class definition 400 and usage code 420 are compiled, in one or more steps, to produce program code in execution-ready form 430. The execution-ready, usage code 436 contains instructions in machine-readable form to instantiate embodiment of objects instance1, instance2, and instance3 during program execution. The execution-ready, attribute-related code 432 contains any machine-readable instructions or data necessary to facilitate storage of the object attributes in computer memory during program execution. The execution-ready, operation-related code 434 contains instructions in machine-readable form to effect the operations as programmed by the programmer.

At execution time, the execution engine/environment loads the execution-ready form of the object-oriented program into computer memory 440. The usage code 446 executes and eventually reaches the instructions corresponding to the line of source code 422 that calls for the instantiation of object instance1. Those instructions, using any attribute-related code 442 as needed, embody instance1 by allocating storage locations 450 in computer memory sufficient to hold all of its attributes. Reaching the instructions corresponding to the line of source code 424 that calls for the instantiation of object instance2 similarly results in the allocation of memory locations 460 sufficient to hold all the attributes of instance2. And again, reaching the instructions corresponding to the line of source code 426 that calls for the instantiation of object instance3 similarly results in the allocation of memory locations 470 sufficient to hold all the attributes of instance3. Thus the depiction of computer memory 440 at execution time in FIG. 4 represents a time during program execution after which instance1, instance2, and instance3 have all been constructed.

The instantiation of each object generally results in the allocation of additional memory to hold the attributes for the new object as just described, while no additional memory is allocated for operation-related code. Because all objects of the identical class perform their operations in the identical way, only one copy of the operation-related code 444 is required. When an operation is invoked, it is pointed to the attributes of one particular object in memory. Accordingly, the attribute data values associated with one particular object become the inputs and/or outputs to the operation program steps, effectively specializing the generalized operation program code to a particular object instance.

An object in computer memory during program execution thus maintains two distinguishable parts. One part is shared with other objects of the same class and includes the instruction code for performing the object's operations. The other part is unique to the object itself and includes the object's attributes. Because they hold an object's uniqueness, the attributes can effectively represent a particular object. In practice, a pointer to an object generally points to this collection of attributes. For example, object pointers 459, 469, and 479, point to objects (i.e., the attribute collections of) instance1 450, instance2 460, and instance3 470, respectively.

In known cases in the art where object externalization is used, externalization of the object involves only the externalization of the object's attributes. It is generally sufficient, and considered more efficient, to externalize only that which makes the particular object unique. For example, an object may be externalized so that a persistent copy of the object may be saved on some storage medium for reuse at a later time, perhaps weeks or months later. The operation-related code 444 for the object does not need to be externalized in such a case because the operations of the object will not be executed while it is in storage.

The embodiment of the invention next described takes advantage of the format of storage of an object's attributes in memory at execution time to provide improved externalization. The development tools used by the programmer to create an object-oriented program, such as a C++ language compiler, typically provide many mechanisms to enforce the integrity of the object as an indivisible combination of attributes and operations. The described embodiment, however, provides a dual view of the object. The standard view is retained, i.e., the object as an indivisible combination of attributes and operations as intrinsically provided by the language development system. The second view, used by an externalizer object, treats the object (i.e., its attributes) as a simple data structure.

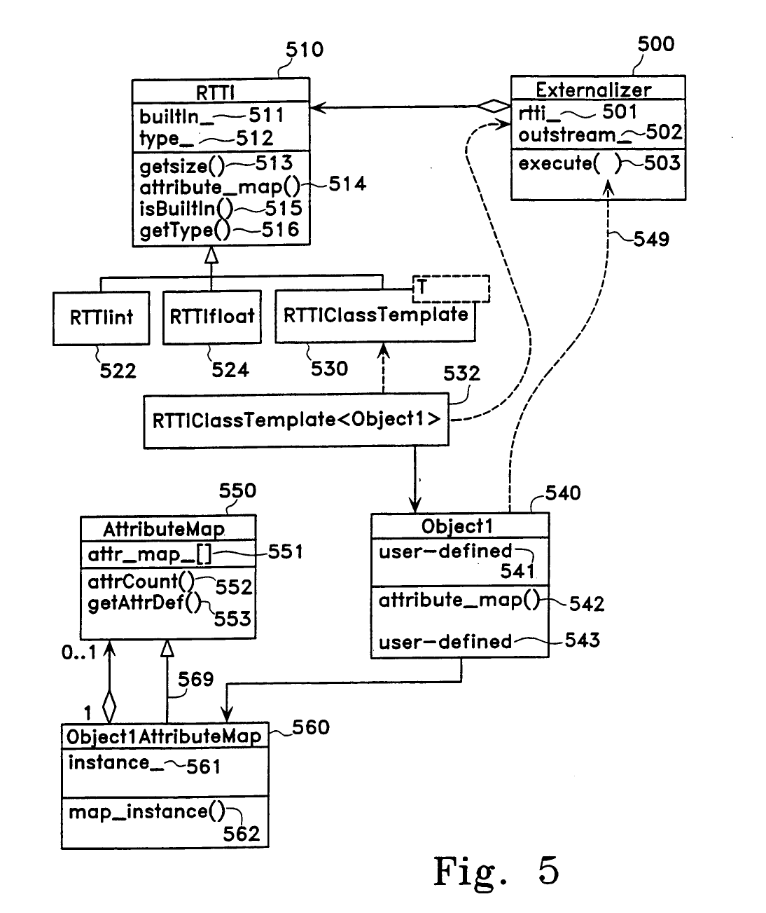

FIG. 5 is a class diagram for computer programming objects useful in an embodiment employing the invention. FIG. 5 generally comports with the diagramming conventions of notation. See, for example, UML Notation Guide version 1.1, dated 1 Sep. 1997. Note that in order not to obscure an understanding of the invention, the present embodiment is described in reference to externalization. One skilled in the art recognizes the need for an internalization counterpart, and can readily deduce the reverse process by understanding the forward one inasmuch as they are essentially mirror images of one another. The present embodiment is also described in reference to elements of the C++ object-oriented source code language where helpful, though the invention is not so limited.

An Externalizer class 500 is shown. An object of this class 500 is a utility object that performs externalization for objects typically of a class other than its own. The removal of the externalization operation from the object being externalized represents an advantage of the present invention.

An Externalizer object is specific to a particular class of object (or built-in data type) to be externalized. An Externalizer object is constructed using a reference to an object of a class derived from the RTTI class, and a reference to the location where the sequence of bytes representing the object in external form should be put. These references are saved in the Externalizer object's rtti_501 and outstream_502 attributes, respectively.

The execute( ) operation 503 of the Externalizer class object performs externalization of an object. A pointer to the particular object to be externalized, illustrated by arrow 549, is supplied as an argument when the execute( ) 503 operation is invoked by the program code requesting externalization. The externalization involves transforming a recognizable data-processing entity, such as a number or a program object, into a secondary form. The secondary form is generally used to communicate the entity outside of the program containing it. The stream of bytes produced by the execute( ) operation may, for example, be sent by the program to another program running on the same computer, to a storage device for later recall, or to another computing device attached to the network.

The secondary form is independent of the primary form of the entity, in that the secondary form is not principally determined by the primary form. The secondary form emphasizes the requirements of the intended receiver.

An object derived from the RTTI class 510 provides information to an Externalizer class 500 object related to viewing an object to be externalized (or built-in data type) as a data structure. RTTI stands for Real-Time Type Identification and is suggestive of a derived object's role in providing data type information related to a particular class of object to Externalizer class execute( ) code during program execution. Like the Externalizer class object, an RTTI-derived object is specific to a particular type of object (or built-in data type) to be externalized.

Two informational items feed into the construction of an RTTI-derived object and construction code stores these as attributes. The builtIn_attribute 511 stores an indicator of whether the RTTI-derived object relates to a built-in data type. The type_512 attribute stores a textual name identifying the type of objects (or built-in data type) the RTTI-derived object represents. The class name may be used as the textual name for RTTI-derived objects representing a class of objects.

Built-in data types are rudimentary data types. A rudimentary-type data item is susceptible to treatment for externalization purposes as an integral unit. For example, while the integer rudimentary data type may consist of several bytes of data, the several bytes of data are first considered by an Externalizer class object as an integral unit that together represent an integer number. Non-built-in types are aggregate types. An item of an aggregate type comprises one or more built-in and/or non-built-in types. Aggregate types are also called user-defined types.

An RTTI-derived object provides information to an Externalizer class object via its operations. The isBuiltIn( ) operation 515 provides an indication of whether the object relates to built-in data type. The getType( ) operation 516 provides the textual name assigned at construction. The getsize( ) operation 513 provides the numeric value indicating the amount of storage space occupied by an item of the particular type. Note that the amount of storage space may be known at compile time for fixed data types such as scaler integers, or may need to be determined real-time as for variable length character string data.

The attribute_map( ) operation 514 generates an error indication if the RTTI-derived object relates to built-in data type. Otherwise the operator returns the value of a pointer to an AttributeMap-derived object, described in detail below. The operation indirectly gets the pointer value by invoking the attribute_map( ) operation belonging to the object which is being externalized.

FIG. 5 shows RTTIint 522 and RTTIfloat 524 classes deriving directly from the RTTI class 510 by inheritance. These classes represent RTTI-derived classes for integer and floating point built-in data types, respectively. RTTIClassTemplate 530 is a template, well-known in the art, that generates no executable code itself. The RTTIClassTemplate 530 rather serves as a generic model that is specialized to individual object types that require externalization.

RTTIClassTemplate<Object1>532 is a class parameterized by Object1 type, and it is derived from the RTTI class 510. An object of RTTIClassTemplate<Object1>532 performs the functions of an RTTI-derived object for objects of class Object1 540.

The Object1 class 540 represents the user-defined class needful of externalization. The programmer defines class Object1 540 to achieve desired data processing objectives of the program in which it is included. Objects of class Object1 540 have user-defined attributes 541 and operations 543. Additionally, the objects have an attribute_map( ) operation 542. This operation is invoked by the RTTI-derived object (i.e., RTTIClassTemplate<Object1>532) related to the class of the instant object. The operation provides a pointer to an AttributeMap-derived object, described in detail below. The operation 542 indirectly gets the pointer value by invoking the map_instance( ) operation of a related AttributeMap-derived object.

FIG. 5 further depicts an AttributeMap class 550. Objects derived from this class build, store, and provide access to information about the individual components of RTTI aggregate types. For the objects of a particular class, an AttributeMap-derived object builds, stores, and provides access to information about the attributes present in each object. The program code of an AttributeMap-derived object in conjunction with that of one or more RTTI-derived objects provide an Externalizer class object with the second programmatic view of an object, i.e., the view of the object as a data structure.

Like the Externalizer class object and the RTTI-derived object, an AttributeMap-derived object is specific to a particular class of object to be externalized. Moreover, a single AttributeMap-derived object is constructed to support all object instances of the related object class. For example, in the presently described embodiment the executing program constructs a single instance of class Object1AttributeMap 560 regardless of the number of instances of class Object1.

An AttributeMap-derived object includes an attribute named attr_map_[ ] 551. As indicated by the square brackets, attr_map_[ ] 551 is a multiple entry, array-like entity, in this case a vector object. Vector objects support an indexable sequence of items and are well understood in the art. Simply, the vector object is an implementation of a list. In the present embodiment each entry in the list corresponds to an attribute of the associated object described using the list.

An AttributeMap-derived object further includes attrCount( ) 552 and getAttrDef( ) 553 operations. The attrCount( ) operation 552 provides the count of the number of attributes contained by an object of the type being described. The getAttrDef( ) operation 553 provides information about one of the attributes contained by an object of the type being described. The program code invoking the getAttrDef( ) operation 553 provides an index value to specify the particular attribute for which it is requesting information.

Class Object1AttributeMap 560 derives from the AttributeMap class 550, inheriting the attr_map_[ ] attribute 551 and the attrCount( ) 552 and getAttrDef( ) 553 operations. These inherited features are shown by virtue of arrow 569 in FIG. 5. Beyond these inherited features, an object of class Object1AttributeMap includes an instance_attribute 561 and a map_instance( ) operation 562. The instance_attribute 561 is static and holds the pointer to the Object1AttributeMap singleton instance. That singleton instance is constructed on the first invocation of the map_instance( ) operation.

The map_instance( ) operation 562 returns the value of the instance_attribute 561. The first time the map_instance( ) operation 562 is invoked the instance_attribute 561 contains an invalid pointer value. Program code of the map_instance( ) operation detects the invalid pointer value. In response, the map_instance( ) operation executes the construction code of a Object1AttributeMap class object which builds in memory an informational entry about each of the individual attributes in an Object1 class 540 object.

The informational entry describing an attribute includes the attribute's location in computer memory relative to the beginning of the object, also called the offset. The construction code builds the collection of attribute offsets by first allocating a temporary work area in memory the same size as that of an object of class Object1 540. The temporary work area is cast as (i.e., treated as though it were) an object of class Object1 540. The base address of the temporary work area is then subtracted from the pointer value for each of the cast object's attributes to determine the individual offset values. In the presently described embodiment the Object1AttributeMap class 560 is declared to be a friend of the Object1 class 540 in order to be able to exact the required information about its private attributes. Friend classes are well understood in the art.

An embodiment may advantageously employ a pre-processor such as represented by compiler 330 in FIG. 3 to automate generation of source code related to improved externalization. A pre-processor is the program code of any program or routine that performs preliminary data processing operations on, and in response to, an input file before passing it on for further processing. Such a pre-processor may insert the attribute_map( ) operation code into user-defined classes, create the class definitions for the AttributeMap-derived classes associated with user-defined classes, and insert code into a user-defined class to make the related AttributeMap-derived class a friend, in response to an input file containing source code for the user-defined class.

The Interface Definition Language (IDL) of CORBA may also be employed to lend a degree of automation to the programming process. The IDL is known in the art. See, for example, Siegel J., CORBA Fundamentals and Programming, John Wiley & Sons, 1996. IDL can be advantageously employed to limit the externalization of an object to a certain subset of its attributes.

An embodiment may also advantageously include providing an application developer with a set of one or more software modules, possibly organized into a library, to deliver standardized and predefined functionality with which to develop and implement programs having improved externalization. Such modules may include, for example, class definitions to include functionality described for the RTTI 510, Externalizer 500, and AttributeMap 550 classes described above. Providing such a set of modules facilitates standardization and reduces the work required of the programmer.

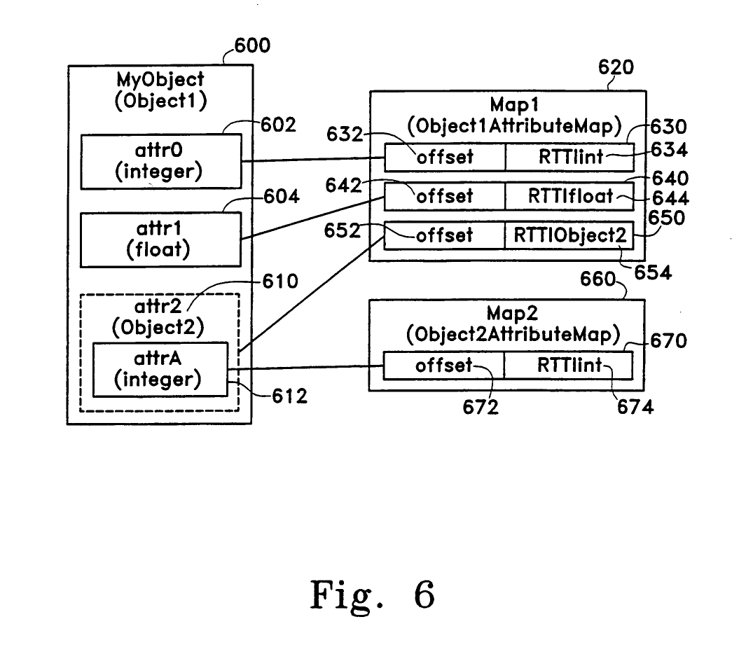

FIG. 6 is a block diagram illustrating exemplary programming objects and their related attribute maps. Exemplary user-defined object, MyObject 600, of class Object1 contains three attributes. Attribute attr0 602 is an integer value. Attribute attr1 604 is a floating point value. Attribute attr2 610 is another user-defined object of class Object2. Attribute/object attr2 itself contains a single attribute, an integer value named attrA 612.

An Object1AttributeMap class object, Map1 620, maps the attributes of MyObject 600. Because an object of class Object1 has three attributes, its corresponding attribute map contains three entries. Each entry includes the offset of the corresponding attribute as discussed above. Each entry also includes a pointer to identify the RTTI-derived object corresponding to the type of the attribute. The offset value 632 in the first entry 630 of Map1 620, for example, indicates the displacement in memory of attribute attr0 602 from the beginning of MyObject 600. The associated RTTI pointer 634 identifies an object of class RTTIint (attr0 is an integer and objects of class RTTIint perform the duties of an RTTI-derived object for the built-in data type “integer”).

In like fashion, the offset value 642 in the second entry 640 of Map1 620 indicates the displacement in memory of attribute attr1 604 from the beginning of MyObject 600. The associated RTTI pointer 644 identifies an object of class RTTIfloat which performs the duties of an RTTI-derived object for the built-in data type “floating point”.

Similarly, the offset value 652 in the third entry 650 of Map1 620 indicates the displacement in memory of attribute attr2 610 from the beginning of MyObject 600. The associated RTTI pointer 654 identifies an object of class RTTIObject2. An object of class RTTIObject2 performs the duties of an RTTI-derived object for user-defined type “Object2”.

Accordingly, the attribute map of Map1 620 provides a description of MyObject 600 based on its attributes. Information about an attribute may be indicated directly or indirectly. In Map1 620, the offset of an attribute is provided directly. The memory location is provided indirectly by combining the offset with the object's base address. Whether the attribute is rudimentary, for example, is also indicated indirectly using the RTTI pointer to get to the RTTI-derived object's isBuiltIn( ) operation.

Attribute attr2 610, as an object, contains its own attributes. In the example shown, the object 610 of class Object2 contains one attribute, an integer value named attrA 612. Because attr2 610 does not belong to the same class as MyObject 600, it will use a different attribute map. Map2 660, an object of class Object2AttributeMap, provides the attribute map for attr2 610. Map2 contains a single entry 670 corresponding to the single attribute 612 of the Object2 class object 610. The offset value 672 in the first entry 670 of Map2 660 indicates the displacement in memory of attribute attrA 612 from the beginning of object attr2 610. The associated RTTI pointer 674 identifies an object of class RTTIint which performs the duties of an RTTI-derived object for the built-in data type “integer”.

Attribute maps are utilized during the process of externalization. An Externalizer constructed for the Object1 class (see FIG. 5) and invoked for the externalization of MyObject 600, gets a reference to Map1 620 using the attribute_map( ) operation of its companion RTTI-derived object (see FIG. 5). For example, the companion in this case may be of class RTTIClassTemplate<Object1>. The Externalizer then works sequentially through the entries contained in the attribute map. If the RTTI-derived object identified by the entry is for a built-in data type, the Externalizer has access to all of the information it needs to identify the storage locations in memory that contain the item and externalization can proceed. This is the case for the attr0 602 and attr1 603 attributes.

If the RTTI-derived object identified by the attribute map entry is for an aggregate type, the Externalizer constructs and invokes a second Externalizer object. The second Externalizer object is constructed with a reference to the RTTI-derived object identified by the attribute map entry. The first Externalizer object invokes the execute( ) operation of the second Externalizer object, specifying the location of the attribute/object in memory. The first Externalizer object calculates the memory location of the attribute/object using the offset value from the attribute map entry. The second Externalizer object then works through a second attribute map that is associated with the class of object it was constructed to externalize. This is the case for the attr2 attribute 610. It is appreciated that operation of Externalizer objects in the present embodiment can thusly be nested.

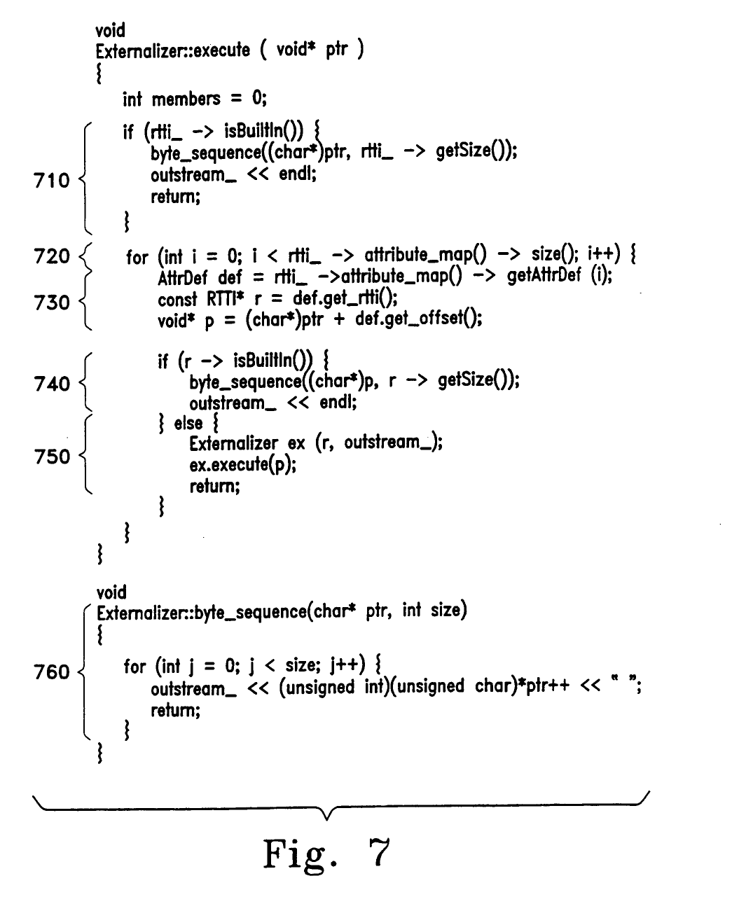

FIG. 7 depicts the source code used in the presently described embodiment to implement the execute( ) operation of an Externalizer class (the execute( ) operation performs externalization data processing steps). Code block 710 processes externalization for built-in data types. The isBuiltIn( ) operation of an RTTI-derived object is invoked to determine whether the construct being externalized is of a built-in type. If so, a byte_sequence( ) operation is invoked to transform the construct to its external form.

The byte_sequence( ) operation of this example is shown in code block 760. For simplicity, the byte_sequence( ) operation merely transfers the bytes in memory containing the item to the output stream, one at a time, starting with the byte at the lowest memory address. The code here can be as simple or complex as necessary to achieve the desired externalized format.

If the external format needs to change in order to accommodate a change in an underlying or companion technology, the Externalizer class definition needs to change accordingly. Note, however, that the class definitions for the user-defined objects being externalized, e.g., Object1 and Object2 of FIG. 6, do not need to change as they are unaware of any external format employed. This represents an advantage of the present invention.

Note also that a number of Externalizer classes may be defined, each of which externalizes to a different external format. A single program including multiple of these classes could be compatible with several underlying or companion technologies at the same time. Moreover, the same object instance of a user-defined class could be externalized to multiple formats in the same program. Further, the combination of Externalizer classes present in the program could be changed over time without making any changes to the definitions of the user-defined classes. These represent further advantages of the present invention.

Code block 720 starts the processing sequence for externalization of user-defined types. The code block establishes a processing loop for stepping through each of the entries in an attribute map for the type.

Code block 730 accesses an entry in the attribute map which corresponds to a particular attribute. Program code captures the identity of an RTTI-derived object associated with the attribute's type. The program code then calculates the memory address of the attribute using the offset from the attribute map entry.

Code block 740 queries the attribute-associated RTTI object to determine whether the attribute is of a built-in type. If so, the attribute is transformed to external form using the byte_sequence( ) operation. If not, code block 750 handles the processing for the user-defined type. In that case the program code constructs a new Externalizer object to process items of the particular user-defined type. The program code invokes the execute( ) operation of the new Externalizer object with a pointer to the attribute. The new Externalizer completes its processing, possibly nesting even further Externalizer objects.

After completion of either code block 740 or 750 the program code returns control to the top of the programming loop established in code block 720, if the entries in the attribute map have not been exhausted.

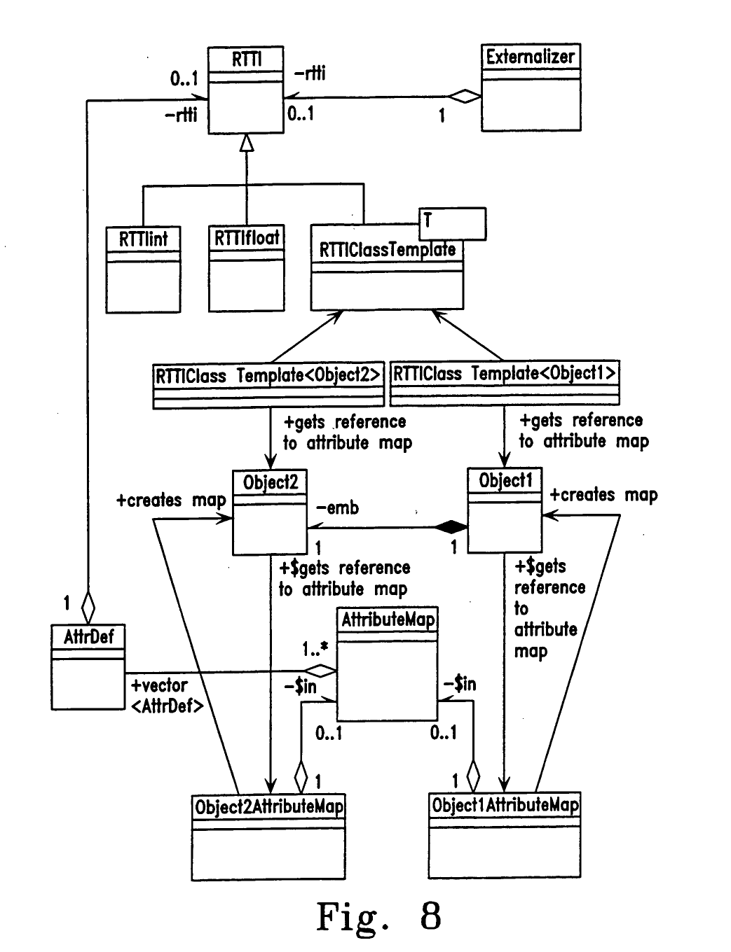

FIG. 8 depicts an expanded class diagram for a sample embodiment employing the invention. The sample embodiment is documented in Appendix A, attached hereto. Appendix A includes source code in the C++ programming language, including a header and implementation file for each of the classes depicted in FIG. 8, as well as for an Internalizer class counterpart to the Externalizer. Appendix A further includes source code for a main( ) function that utilizes objects derived from each of the classes to demonstrate both externalization and internalization practiced in accordance with the present invention. Lastly, Appendix A includes a printout resulting from the execution of the main( ) function. The sample embodiment demonstrates improved externalization. It does not include the data processing step of conveying the external format data stream outside of the program.

Various modifications to the preferred embodiment can be made without departing from the spirit and scope of the invention. Thus, the foregoing description is not intended to limit the invention which is described in the appended claims in which:

1. A method for developing an object-oriented computer program that facilitates externalization of an object in the program, comprising:
including program code within computer-readable storage, the program code defining computer operations for providing in memory a description of an instance of a program object residing in memory during execution;
wherein the description is based on one or more attributes of the instance;
wherein the description indicates positions of the attributes in memory locations occupied by the instance during execution;
and wherein the description is usable by program code outside of the instance to retrieve values of the attributes from the memory locations.

2. The method of claim 1 wherein the positions of the attributes in memory locations are indicated by relative offset memory addresses.

3. The method of claim 2 wherein the relative offset memory addresses are relative to a base address corresponding to a pointer value for the instance in memory.

4. The method of claim 1 wherein the description comprises a set of entries, and each of the attributes is associated with an entry in the set.

5. The method of claim 4 wherein the type of the attribute associated with an entry in the set is indicated in the entry.

6. The method of claim 4 wherein the amount of space in memory allotted to the attribute associated with an entry in the set is indicated in the entry.

7. Program code embodied on a computer-readable medium to direct execution in a computer system to construct an attribute map of a program object to facilitate external storage, transmission, or display of an object, comprising:
code for allocating a memory area sufficient to hold an instance of an object of a first class having one or more attributes;
code for obtaining a base address of the allocated memory area;
code for casting the memory area as a first instance of an object of the first class;
code for obtaining a pointer value for an attribute of the first instance;
code for calculating an attribute offset address using the pointer value and the base address; and
code for storing the attribute offset address in an attribute map area relating to the first class.

8. The invention of claim 7 further comprising code repeating for each additional of the one or more attributes, the code for obtaining a pointer value, the code for calculating, and the code for storing.

9. The invention of claim 7 further comprising program code for execution outside of an object of the first class, comprising:
code for obtaining a base pointer value for a second instance of an object of the first class;
code for retrieving the attribute offset address;
code for calculating a memory address for an attribute value of the second instance using the retrieved attribute offset address and the base pointer value;
code for retrieving the attribute value using the calculated memory address; and
code for processing the retrieved attribute value for externalizing the second instance.

10. A method in a computer system for producing an external form of a runtime computer programming object for display, transmission, or storage, comprising:
allocating a memory area sufficient to hold an instance of an object of a first class having at least one attribute;
obtaining a base address of the allocated memory area;
casting the memory area as a first instance of an object of the first class;
obtaining a pointer value to the attribute of the first instance;
calculating an attribute offset address for the attribute using the base address and the pointer value;
storing the calculated attribute offset address in an attribute map relating to the first class;
obtaining a base pointer value for a second instance of an object of the first class, the second instance to be externalized;
deriving a location in memory for the attribute of the second instance using the base pointer value and the stored attribute offset address;
retrieving the value of the attribute of the second instance from the derived location in memory; and
externalizing the second instance using the retrieved attribute value.
